(19) United States
(12) Patent Application Publication
(10) Pub. No.: US 2025/0174649 A1
(43) Pub. Date: May 29, 2025

(54) DISORDERED ROCK-SALT BATTERY CATHODE COMPOSITION AND SYNTHESES THEREOF

(71) Applicant: Toyota Research Institute, Inc., Los Altos, CA (US)

(72) Inventors: Steven Bartholomew Joseph Torrisi, Berkeley, CA (US); Christopher Wolverton, Wilmette, IL (US); Yizhou Zhu, Hangzhou (CN); Tzu-Chen Liu, Evanston, IL (US); Bianca Baldassarri, Jagna (PH); Adolfo Salgado-Casanova, Chicago, IL (US); Muratahan Aykol, San Jose, CA (US); So Yubuchi, Nagaizumi-cho, Sunto-gun (JP); Hisatsugu Yamasaki, Gotemba-shi (JP); Jun Yoshida, Mishima-shi (JP)

(73) Assignees: Toyota Research Institute, Inc., Los Altos, CA (US); Toyota Jidosha Kabushiki Kaisha, Toyota-shi Aichi-ken (JP); Northwestern University, Evanston, IL (US)

(21) Appl. No.: 18/897,372

(22) Filed: Sep. 26, 2024

Related U.S. Application Data
(60) Provisional application No. 63/603,828, filed on Nov. 29, 2023.

(51) Int. Cl. H01M 4/525; C01G 37/14; C01G 49/00; C01G 53/00; H01M 4/02

(52) U.S. Cl. CPC H01M 4/525; C01G 37/14; C01G 49/0027; C01G 53/42; C01P 2002/50; C01P 2006/40; H01M 2004/028

(57) ABSTRACT

A cathode material has the chemical formula Li_{4+δ}Mₓ₁M′_{y1}M″_{z1}O₈ or Li_{2+δ}Mₓ₂M′_{y2}M″_{z2}O₄ where 0≤δ≤1, x1, y1, z1 are integers (+/−0.5) and x1+y1+z1=4, and x2, y2, z2 are integers (+/−0.05) and x2+y2+z2=2. A method for discovering a cathode material includes estimating synthesizability for a plurality of cathode material compositions, selecting a first subset of cathode material compositions from the plurality of cathode material compositions as a function of the estimated synthesizability and metal-ion diffusion availability, estimating voltage discharge, charge capacity, and oxygen stability for the first subset of cathode material compositions, and selecting a second subset of cathode material compositions from the first subset plurality of cathode material compositions as a function of the estimated voltage discharge, charge capacity, and oxygen stability.

### CROSS-REFERENCE TO RELATED APPLICATIONS

This application claims the benefit of U.S. Provisional Application No. 63/603,828, filed Nov. 19, 2023, which is incorporated herein in its entirety by reference.

### TECHNICAL FIELD

The present disclosure relates generally to battery cathode materials and particularly to battery cathode materials with a rock salt type crystal structure.

### BACKGROUND

A cathode is a key component of a battery or fuel cell. Particularly, the cathode serves as a positive electrode where cations migrating from an anode and through an electrolyte electrochemically react with electrons arriving at the cathode via an external circuit. In addition, discovery and/or development of new materials from which cathodes are formed (i.e., cathode materials) can be desirable. However, the development of such cathode materials can be time and cost intensive.

The present disclosure addresses issues related to new cathode materials, the development and/or discovery of new cathode materials, and other issues related to cathode materials.

### SUMMARY

This section provides a general summary of the disclosure and is not a comprehensive disclosure of its full scope or all of its features.

In one form of the present disclosure, a cathode for a Li ion battery includes a cathode material with the chemical formula Li_{4+δ}Mₓ₁M′_{y1}M″_{z1}O₈ or Li_{2+δ}Mₓ₂M′_{y2}M″_{z2}O₄, and where 0≤δ≤1, x1, y1, z1 are integers and x1+y1+z=4, x2, y2, z2 are integers and x2+y2+z2=2, and M, M′, and M″ are elements selected independently from hafnium (Hf), magnesium (Mg), aluminum (Al), scandium (Sc), titanium (Ti), vanadium (V), chromium (Cr), manganese (Mn), iron (Fe), cobalt (Co), nickel (Ni), copper (Cu), gallium (Ga), zirconium (Zr), niobium (Nb), ruthenium (Ru), tin (Sn), and antimony (Sb).

In another form of the present disclosure, a method includes estimating synthesizability and metal-ion diffusion availability for a plurality of cathode material compositions with the chemical formula Li_{4+δ}Mₓ₁M′_{y1}M″_{z1}O₈ or Li_{2+δ}Mₓ₂M′_{y2}M″_{z2}O₄ where 0≤δ≤1, x1, y1, z1 are integers and x1+y1+z1=4, x2, y2, z2 are integers and x2+y2+z2=2, and M, M′, and M″ are at least two different cation elements. The method also includes selecting a first subset of cathode material compositions from the plurality of cathode material compositions as a function of the estimated synthesizability and metal-ion diffusion availability, and estimating voltage discharge, charge capacity, and oxygen stability for the first subset of cathode material compositions. The method further includes selecting a second subset of cathode material compositions from the first subset of cathode material compositions as a function of the estimated voltage discharge, charge capacity, and oxygen stability, and synthesizing and evaluating at least one of the second subset of cathode material compositions.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings, wherein:

FIG. 1 shows a Lithium-ion battery cell;

FIG. 2 shows a flow chart for a method of developing a cathode material according to one form of the present disclosure;

FIG. 3 shows four different crystal structures used in the development of cathode materials according to the teachings of the present disclosure;

FIG. 4 shows a flow chart for another method of developing a cathode material according to another form of the present disclosure;

FIG. 5 shows a flow chart for another method of developing a cathode material according to still another form of the present disclosure; and

FIG. 6 shows an empirically derived decision tree according to the teachings of the present disclosure.

### DETAILED DESCRIPTION

The present disclosure provides new cathode materials with a disordered-rock-salt (DRX) crystal structure and/or a combined DRX+layered crystal structure, methods for discovering new cathode materials with a DRX crystal structure and/or a combined DRX+layered crystal structure, and methods for synthesizing new cathode materials with a DRX crystal structure and/or a combined DRX+layered crystal structure. In some variations, the cathode materials with the DRX crystal structure (referred to hereafter as “DRX cathode material” or “DRX cathode materials”) and/or the combined DRX+layered crystal structure (referred to hereafter as “DRX/layered cathode material or “DRX/cathode materials”) form at least a portion of a cathode for a secondary battery, e.g., a cathode of a Li-ion secondary battery. And in such variations, the DRX and/or DRX/layered cathode materials have reduced volume change during charging and discharging of the secondary battery. In at least one variation, the DRX crystal structure of the DRX and/or DRX/layered cathode materials exhibit enhanced ion diffusion and thereby provide for reduced charging times for secondary batteries. And in some variations, the DRX and/or DRX/layered cathode materials do not include relatively costly elements such as cobalt. As used herein, the phrase “disordered-rock-salt crystal structure” refers to a crystal structure with the Fm-3m symmetry group, made up of alternating layers of oxygen and cations (which may be transition metals or lithium), where the transition metals and lithium atoms may occupy any site on the cation sublattice in any pattern—this is in contrast with ordered phases, where a distinct pattern is observed of no mixing between the lithium and transition metals (in other words, cation layers are either all-Li or all-TM).

The present disclosure also provides systems and/or methods for discovering cathode materials with the DRX crystal structure. The methods include estimating synthesizability and metal-ion diffusion (e.g., Li-ion diffusion) for a plurality of cathode material compositions having a rock salt type crystal structure, and based on the estimated synthesizability and metal-ion diffusion, selecting a first or initial subset of cathode material compositions for further study. The methods also include estimating voltage discharge (e.g., the average voltage during discharging or the voltage window during operation), gravimetric charge capacity, and oxygen stability of the first subset of cathode material compositions, and based on the estimated voltage discharge, gravimetric charge capacity, and oxygen stability, selecting a second subset of cathode material compositions from the first subset. In this manner, the second subset of cathode material compositions are filtered out or selected from the plurality of cathode material compositions as having the best chance or probability of being feasibly manufactured (synthesized) as a DRX cathode material and being suitable from a performance perspective. Stated differently, the systems and/or methods predict a subset of cathode material compositions that have a DRX crystal structure and a desired combination of manufacturability and performance, and thereby reduce the cost and time of developing new cathode materials.

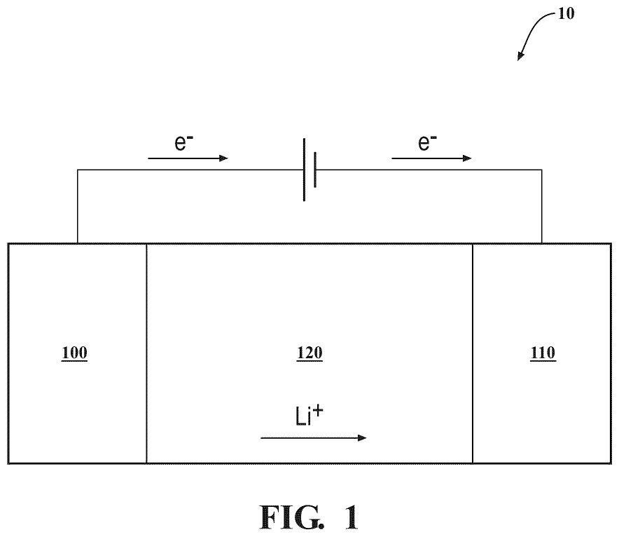

Referring to FIG. 1, a lithium (Li) ion battery 10 with an anode 100, a cathode 110, and an electrolyte 120 is shown. In some variations, the cathode 110 is formed from a DRX or DRX/layered cathode material having the chemical formula Li_{4+δ}MₓM′_{y}M″_{z}O₈ or Li_{2+δ}Mₓ₂M′_{y2}M″_{z2}O₄, where M, M′, and M″ are one or more elements selected from magnesium (Mg), aluminum (Al), calcium (Ca), scandium (Sc), titanium (Ti), vanadium (V), chromium (Cr), manganese (Mn), iron (Fe), cobalt (Co), nickel (Ni), copper (Cu), zinc (Zn), gallium (Ga), germanium (Ge), yttrium (Y), zirconium (Zr), niobium (Nb), molybdenum (Mo), ruthenium (Ru), rhodium (Rh), palladium (Pd), cadmium (Cd), indium (In), tin (Sn), antimony (Sb), hafnium (Hf), tantalum (Ta), tungsten (W), iridium (Ir), lead (Pb), and bismuth (Bi). In some variations, 0≤δ≤1, while in other variations 0≤δ≤1. In at least one variation, 0≤δ<1, and in some variations 0≤δ<1. Also, the coefficients x1, y1, z1 are integers (+/−0.05) (referred to hereafter simply as “integers”) with x1+y1+z=4, and x2, y2, z2 are integers (+/−0.05) with x2+y2+z2=2, where the phrase “integers (+/−0.05)” refers to a range of values between −0.05 and +0.05 of a given integer value. For example, for the chemical formula Li_{4+δ}HfTiV₂O₈ refers to compositions between Li_{4+δ}Hf_{0.95}Ti_{0.95}V_{1.95}O₈ and Li_{4+δ}Hf_{1.05}Ti_{1.05}V_{2.05}O₈, inclusive. Also, in some variations x1, y1, z1 are integers (+/−0.05) not equal to zero and/or x2, y2, z2 are integers (+/−0.05) not equal to zero.

In some variations, M and M′ are the same element and M″ is a different element (M=M′≠M″), while in other variations, M′ and M″ are the same element and M is a different element (M #M′=M″). And in some variations, M, M′, and M″ are all different elements (M #M′≠M″). Also, in some variations, 0≤δ<1, while in other variations 0≤δ≤1. In at least one variation, 0≤δ<1, and in some variations 0≤δ<1.

Non-limiting examples of DRX and/or DRX/layered cathode materials according to the teachings of the present disclosure include Li_{2+δ}TiVO₄, Li_{2+δ}VFeO₄, Li_{4+δ}HfTiV₂O₈, Li_{4+δ}VFe₂SnO₈, Li_{4+δ}ScV₂FeO₈, Li_{4+δ}CrFeNi₂O₈, Li_{4+δ}Mn₂CoRuO₈, Li_{4+δ}Mn₂NiRuO₈, Li_{4+δ}CrFe₂NiO₈, Li_{4+δ}HfCrFe₂O₈, Li_{4+δ}ZrV₃O₈, Li_{4+δ}Mn₂NiSbO₈, Li_{4+δ}Mn₂CoSbO₈, Li_{4+δ}Cr₂FeCuO₈, Li_{4+δ}Cr₂FeNiO₈, Li_{4+δ}TiCrFe₂O₈, Li_{4+δ}HfV₃O₈, Li_{4+δ}Mn₂FeRuO₈, Li_{4+δ}MnCrNi₂O₈, Li_{4+δ}Cr₂GaFeO₈, Li_{4+δ}ZrCrFe₂O₈, Li_{4+δ}Ti₂VCrO₈, Li_{4+δ}ZrV₂FeO₈, Li_{4+δ}FeCo₂RuO₈, Li_{4+δ}Fe₂CoRuO₈, Li_{4+δ}CrFe₂SnO₈, Li_{4+δ}CrFe₂CuO₈, Li_{4+δ}Fe₂NiSbO₈, Li_{4+δ}ScMnV₂O₈, Li_{4+δ}ScTiV₂O₈, Li_{4+δ}MnV₂FeO₈, Li_{4+δ}MnCo₂RuO₈, Li_{4+δ}HfV₂FeO₈, Li_{4+δ}TiCr₂CuO₈, Li_{4+δ}TiV₃O₈, Li_{4+δ}ScCr₂NiO₈, Li_{4+δ}Mn₂CrFeO₈, Li_{4+δ}V₂FeSnO₈, Li_{4+δ}TiVFe₂O₈, Li_{4+δ}Cr₂CuNiO₈, Li_{4+δ}MnNbFe₂O₈, Li_{4+δ}NbFe₂NiO₈, Li_{4+δ}V₂GaFeO₈, Li_{4+δ}V₃FeO₈, Li_{4+δ}AlV₂FeO₈, Li_{4+δ}CrNi₂SnO₈, and Li_{4+δ}TiCrNi₂O₈.

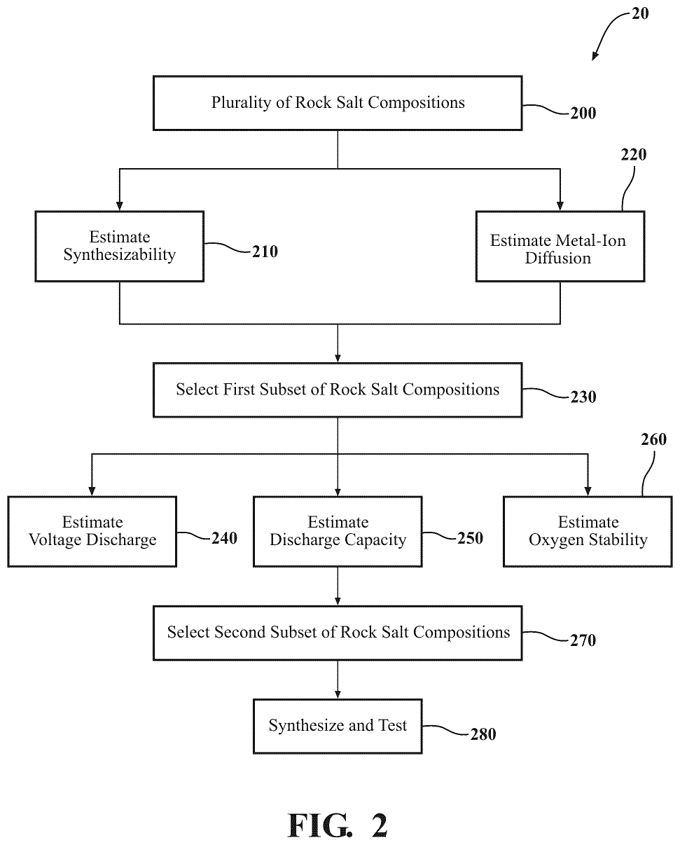

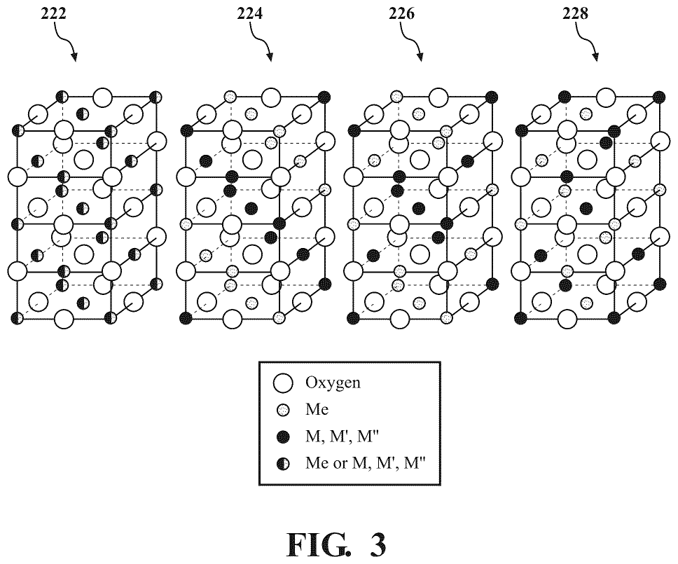

Referring to FIG. 2, a method 20 of discovering DRX cathode materials includes selecting, providing, and/or generating a plurality of cathode material compositions having a rock salt type crystal structure at 200, estimating a synthesizability for each of the cathode material compositions at 210, and estimating the metal-ion diffusion for each of the cathode material compositions at 220. As used herein, the term “synthesizability” refers to the thermodynamic stability of a predefined phase (i.e., crystal structure) at a predefined temperature (e.g., 1000° C.) for a given cathode material composition. In some variations, estimating the synthesizability for each of the cathode material compositions at 210 includes estimating the phase stability of a DRX crystal structure 222 and one or more of a layered crystal structure 224, a spinel-like crystal structure 226, and a γ-LiFeO₂-like crystal structure 228 illustrated in FIG. 3 and described in greater detail in the reference Alexander Urban, Jinhyuk Lee, Gerbrand Ceder, “The Configurational Space of Rocksalt-Type Oxides for High-Capacity Lithium Batteries”, Advanced Energy Materials, Vol. 4, Issue 13, Sep. 16, 2014. As used herein, the phrase “layered crystal structure” refers to a crystal structure in which atoms are chemically bonded in plane layers of the crystal structure in the R-3m space group in sets of four alternating layers in the pattern of layers of oxygen, transition metals, oxygen, and lithium. And in some variations, the cathode material compositions generated at 200 have the formula Li_{1+δ}MₓM′_{y}M″_{z}O₂, Li_{2+δ}MₓM_{y}M″_{z}O₄ and/or Li_{4+δ}MM′_{y}M″_{z}O₈ where M, M′, and M″ are chosen from the elements listed above.

In some variations the available oxidation states of cations and/or octahedral coordination preference of each cation in oxides are/is determined for each of the cathode material compositions. And in at least one variation, the generation of the cathode material compositions at 200 includes each of the cathode material compositions being charge balanced and having a cation redox capability of extracting at least 0.5 Li per formula unit.

In some variations, estimating the synthesizability at 210 includes designing a Special Quasirandom Structure (SQS) as a representative supercell for each of the DRX crystal structure 222, the layered crystal structure 224, the spinel-like crystal structure 226, and the γ-LiFeO₂-like crystal structure 228 (collectively referred to herein as “crystal structures 222-228), and predicting the mixing enthalpy of disordering for each cathode material composition—crystal structure combination. In at least one variation, the SQSs are designed as taught in the reference Phys. Rev. Lett. 1990, 65, 353, by A. Zunger et al., which is incorporated herein in its entirety by reference.

Not being limited by theory, a SQS is a limited-size low-symmetry periodic supercell chosen to have cluster correlations close to their random limit, and a SQS can be used to effectively predict the mixing enthalpy and order-disorder transition temperature of a DRX. In some variations, shorter (smaller) clusters of atoms are assumed to provide enhanced prediction characteristics or estimates, and in such variations an objective function to be minimized can take the form:

$$Q = - ω L + {\sum }_{α} \vert {Γ}_{α}^{SQS} - {Γ}_{α}^{rnd} \vert \qquad ( 1 )$$

where ω is a customizable weight parameter and L is the maximum cluster length such that all correlations δ_{α} for clusters α with diameter less than L in an SQS agree with the targeted random distribution.

In some variations, 64-atom SQSs for the crystal structures 222-228 are generated and four 128-atom SQSs for the crystal structures 222-228 are also generated to test size convergence. In at least one variation, the SQSs for the DRX crystal structure of each of the cathode material compositions are generated with the element ratio of Li(M_{0.5}M′_{0.25}M″_{0.25})O₂ and all cations are allowed to randomly mix on all cation sites. And the SQSs for the layered, spinel-like, and γ-LiFeO₂-like crystal structures are designed with same the Li_{0.5}M′_{0.25}M″_{0.25} ratio, but with Li on its own sublattice and the M, M′, and M″ cations placed and mixed on the remaining cation sites as random as possible.

For example, in some variations, the mixing enthalpy of disordering is calculated for each cathode material composition represented by the SQSs for the crystal structures 222-228 using first principles energy calculations (e.g., Density Functional Theory (DFT) calculations), and Long Range Order (LRO) and Short Range Order (SRO) crystal structure preferences are estimated for each cation combination (i.e., each crystal structure for each cathode material composition) based on the first principles energy calculations. In at least one variation, DFT energies for the SQSs are transformed to convex hull energies (Eₕᵤₗₗ) generated with the Open Quantum Materials Database (OQMD) as taught in the reference npj Comput Mater 2015, 1, 1, by S. Kirklin et al., and the reference JOM 2013, 65, 1501, by J. E. Saal et al., both of which are incorporated herein in their entirety by reference.

In some variations, high-throughput DFT (HT-DFT) energy calculations are executed using the OQMD framework with coarse ionic relaxations first performed with OQMD default DFT settings. In such variations, the HT-DFT energy calculations are converged to 10⁻³ eV for ionic relaxation loop and 10⁻⁴ eV for electronic SC-loop, followed by static calculations with 520 eV cutoff energy for plane wave basis set and 8,000 k-points per reciprocal atom (KPPRA). Fine ionic relaxations are then performed for top candidates to check force convergence with a 520 eV cutoff energy and 8000 KPPRA converged to 10⁻² eV Å⁻¹ for ionic relaxation loop, followed by final static calculations converged to 10⁻⁶ eV to get energies transformed to Eₕᵤₗₗ.

In some variations, the Eₕᵤₗₗ energies are compared with TS_{config} where T=1273 K and S_{config} is the ideal configuration entropy from the mixing sites and final Eₕᵤₗₗ−TS_{config} free energies are used for predicting LRO tendency for each composition. And in at least one variation, the SRO for each of the four SQS representative supercells is assumed to be the same as the LRO.

In some variations, estimating the metal-ion diffusion at 220, a SQS is designed as a representative short-range order (SRO) cell each of the DRX crystal structure 222, the layered crystal structure 224, the spinel-like crystal structure 226, and the γ-LiFeO₂-like crystal structure 228. Not being bound by theory, and for example, for rock salt-type LiMO₂, a relevant SRO to Li diffusion is from the smallest 4-body cluster of the Oₕ site. Stated differently, the population and connectivity of the Li₄ (0-TM) cluster are the significant factors for the SQS. In some variations, the sensitivity of the preference of each composition for an Li₄ or Li-M mixing configuration is considered for a screening strategy.

In some variations, the SQS for the LRO spinel-like crystal structure and the SQS for the LRO γ-LiFeO₂-like crystal structure were used as a first approximation of the SQS for the SRO spinel-like crystal structure and the SQS for the SRO γ-LiFeO₂-like crystal structure, respectively. However, it should be understood that the SRO parameter(s) for DRX crystal structures is a function of a local chemical ordering effect and the LRO parameter for DRX crystal structures should equal zero, i.e., there is no well-defined ordering on the metal-ion sublattice. Accordingly, the SQS for a metal-ion ordered sublattice is not the actual or theoretically accurate representation of disorder materials with specific SRO, but SRO and LRO have been found to be same type and has been sued to explain the SRO tendency in DRX crystal structures. Accordingly, the SQS for the LRO spinel-like crystal structure and the SQS for the LRO γ-LiFeO₂-like crystal structure were used for qualitative estimates of the SRO energetics for the plurality of cathode material compositions and the SRO descriptor was designed to be the Eₕᵤₗₗ difference between the spinel-like crystal structure and the γ-LiFeO₂-like crystal structure.

The method 20 selects a first subset of cathode material compositions from the cathode material compositions at 230 based on the estimated synthesizability and/or the metal-ion diffusion of each of the cathode material compositions executed or performed at 210, 220, respectively. Stated differently, the cathode material compositions that exhibit a tendency of being synthesized and stable in a desired phase are selected as the first subset of cathode material compositions for continued study. For example, in some variations the first subset of cathode material compositions is selected from the cathode material compositions exhibiting a tendency of being synthesized and having the DRX crystal structure 222 and/or the layered crystal structure 224. As used herein, the phrase “tendency” refers to a qualitative and/or quantitative measurement or calculation for a desirable result using known chemical and/or physical properties. For example, in some variations a tendency of being synthesized refers to a quantitative calculation and/or formation energy calculated value for a cathode material composition having the DRX crystal structure 222.

The method 20 estimates a voltage discharge for each of the first subset of cathode material compositions at 240, a discharge capacity for each of the first subset of cathode material compositions at 250, and an oxygen stability for each of the first subset of cathode material compositions at 260. In some variations, the voltage discharge is estimated with metal-ion chemical potentials of ground states by Grand Canonical Linear Programing (GCLP) and the discharge capacity is estimated from the cation redox contribution.

For example, in some variations, the grand canonical free energy Ω(μ_{Li}) at each Li chemical potential μ_{Li}; is assumed to be directly related to the voltage and has the form:

$$Ω ( {μ}_{Li} ) = {\sum }_{j} {x}_{j} {F}_{j} - {μ}_{Li} {\sum }_{j} {x}_{j} {n}_{j}^{Li} \qquad ( 2 )$$

where xⱼ is the molar fraction of phase j with corresponding free energy Fⱼ and Li amounts per formula unit of nⱼ^{Li}. Also, Ω(μ_{Li}) is then the objective function of the linear programming problem with respect to variables x while holding the conservation constraint on other species.

The method 20 selects a second subset of cathode material compositions from the first subset of cathode material compositions based on the voltage discharge, discharge capacity, and/or oxygen stability at 270. In some variations, the method 20 includes synthesizing and evaluating (testing) on at least a portion of the second subset or cathode material compositions at 280. Stated differently, the first subset of cathode material compositions that exhibit a voltage discharge, discharge capacity, and/or oxygen stability above or below a predefined value are selected as the second subset of cathode material compositions for continued synthesizing and testing at 280.

Still referring to FIG. 2, in at least one example, approximately six thousand (6,000) possibly cathode material compositions were generated at 200, forty-four (44) cathode material compositions were selected as the first subset of cathode material compositions at 230, and eight (8) cathode material compositions were selected as the second subset of cathode material compositions at 270. The first subset of cathode material compositions selected at 230 are below in Table 1, along with LRO predictions based on approximate free energyF(meV/atom)=Eₕᵤₗₗ-TS_{config}, theoretical maximum cation capacity, grand canonical linear programming (GLCP) average voltage, GCLP voltage drop, and SRO predictions.

The theoretical maximum cation capacity is computed by assuming a range of oxidation states that each transition metal can assume in the composition and that respectively during charge/discharge the transition metals are oxidized/reduced to their respective maximum/minimum oxidation states. From here, assuming a unit charge associated with each in units of milli-ampere hours, a gravimetric charge capacity may be estimated. The GCLP estimations are performed by comparing the energies obtained from first-principles simulation associated with each phase against a database of known phases, and computing the change in energy that would result from decomposition of the chemical compound in question to the most stable known forms of the constituent elements. This problem—solved using the formalism of linear programming—is performed at varying Li chemical potential, which allows an estimate of how this decomposition energy changes as a function of Li content of the composition. This change in energy as Li is inserted into the material (during intercalation) can be estimated by this process, and when interpreted as the change in energy of the cathode during lithiation and delithiation, can be used to estimate what the operating voltage of the cathode looks like. Taking the average of this voltage over a range of lithiation/delithiaton gives the average voltage, and taking the max-min (voltage drop) gives an estimate of the voltage window. This procedure is detailed elsewhere in Akbarzadeh, Alireza R., Vidvuds Ozoliins, and Christopher Wolverton, “First-principles determination of multicomponent hydride phase diagrams: application to the Li—Mg—NH system.” Advanced Materials (Weinheim) 19 (2007).

TABLE 1

| | | | | | Theoretical | | | |
|---|---|---|---|---|---|---|---|---|
| | | | | | Maximum | | | |
| | | | | | Cation | GCLP | GCLP | |
| | | | | | Capacity | Average | Voltage | |
| | | | | | (mAh/g- | Voltage | Drop | SRO |
| Composition | F_{DRX} | F_{layered} | Fₛₚᵢₙₑₗ₋ₗᵢₖₑ | F_{γ-LiFeO2} | Li1.2) | (V) | (V) | Predictors |
| Li₄HfTiV₂O₈ | −11.9 | −9.5 | −10 | −14.7 | 202 | 2.5 | 1.1 | 4.7 |
| Li₄VFe₂SnO₈ | −10.8 | −0.3 | −0.8 | 6.7 | 166 | 3.1 | 1.5 | −7.5 |
| Li₄ScV₂FeO₈ | −8 | −5.2 | 0.2 | −2.3 | 199 | 2.9 | 1.8 | 2.5 |
| Li₂TiVO₄ | −7.1 | −20.9 | −19 | −14.5 | 269 | 2.7 | 1.1 | −4.5 |
| Li₄CrFeNi₂O₈ | −7 | −10.4 | −9.8 | 10.6 | 251 | 3.2 | 0.9 | −20.4 |
| Li₄Mn₂CoRuO₈ | −5.7 | −11.8 | −7.1 | 8 | 227 | 3.2 | 1.2 | −15.1 |
| Li₄Mn₂NiRuO₈ | −4.7 | −17.4 | −16.3 | 1.6 | 227 | 3.2 | 0.8 | −18 |
| Li₄CrFe₂NiO₈ | −2.8 | −24.4 | −20.6 | 2 | 253 | 3.3 | 0.9 | −22.5 |
| Li₂VFeO₄ | −2.7 | 2.9 | 2.7 | 17.2 | 258 | 3.2 | 1.4 | −14.5 |
| Li₄HfCrFe₂O₈ | −1 | 4.7 | 2.7 | −4.8 | 197 | 3.2 | 0.9 | 7.5 |
| Li₄ZrV₃O₈ | 0.5 | 5 | 1.8 | −3.9 | 301 | 2.6 | 1.6 | 5.8 |
| Li₄Mn₂NiSbO₈ | 1.4 | 16.6 | 20.4 | 5.8 | 163 | 3.2 | 1 | 14.6 |
| Li₄Mn₂CoSbO₈ | 1.7 | 28.8 | 28.3 | 15.9 | 163 | 3.1 | 1.1 | 12.4 |
| Li₄Cr₂FeNiO₈ | 2.2 | −9.9 | −24.8 | 6.7 | 383 | 3.5 | 1.2 | −31.6 |
| Li₄TiCrFe₂O₈ | 2.4 | −10.8 | −10.6 | 1.6 | 259 | 3.4 | 0.9 | −12.2 |
| Li₄HfV₃O₈ | 2.8 | 2.6 | 0.4 | −6.8 | 251 | 2.7 | 1.4 | 7.2 |
| Li₄Mn₂FeRuO₈ | 2.9 | −4.4 | −0.3 | 9.3 | 229 | 3.2 | 1.1 | −9.6 |
| Li₄MnCrNi₂O₈ | 3 | −14.7 | −10.3 | 21.3 | 252 | 3.2 | 1.1 | −31.5 |
| Li₄ZrCrFe₂O₈ | 3 | 5.8 | 4.3 | −4.1 | 235 | 3.2 | 0.9 | 8.4 |
| Li₄Ti₂VCrO₈ | 3.1 | −6.2 | −5.9 | −2.6 | 335 | 3.2 | 1.7 | −3.2 |
| Li₄ZrV₂FeO₈ | 3.5 | 25.2 | 21.4 | 8 | 238 | 2.8 | 2 | 13.3 |
| Li₄FeCo₂RuO₈ | 3.8 | 3.9 | 0.8 | 35.8 | 225 | 3.4 | 0.3 | −35 |
| Li₄Fe₂CoRuO₈ | 3.9 | −2.2 | −9.6 | 12.8 | 226 | 3.4 | 0.4 | −22.4 |
| Li₄CrFe₂SnO₈ | 4.1 | −4.8 | −4.7 | 1.6 | 221 | 3.3 | 0.9 | −6.3 |
| Li₄CrFe₂CuO₈ | 4.2 | 29.6 | 4.5 | 8.1 | 187 | 3.3 | 0.8 | −3.7 |
| Li₄Fe₂NiSbO₈ | 5.1 | 14.2 | 14.2 | 28.6 | 163 | 3.4 | 0.3 | −14.5 |
| Li₄ScMnV₂O₈ | 5.2 | 19.4 | 17.7 | 5.8 | 199 | 2.9 | 1.9 | 11.9 |
| Li₄ScTiV₂O₈ | 6.1 | −18.4 | −15.6 | −19.8 | 203 | 2.5 | 1.1 | 4.1 |
| Li₄MnV₂FeO₈ | 6.2 | 14.3 | 11.1 | 14.5 | 259 | 3.2 | 1.6 | −3.4 |
| Li₄MnCo₂RuO₈ | 6.2 | −1.5 | 13.4 | 23.8 | 225 | 3.3 | 0.9 | −10.3 |
| Li₄HfV₂FeO₈ | 6.7 | 14.4 | 15.2 | 10 | 199 | 2.8 | 1.9 | 5.2 |
| Li₄TiV₃O₈ | 6.9 | −14.7 | −13.6 | −3 | 333 | 2.9 | 1.2 | −10.7 |
| Li₄ScCr₂NiO₈ | 6.9 | 15.7 | −0.9 | 19.4 | 327 | 3.4 | 1.2 | −20.3 |
| Li₄Mn₂CrFeO₈ | 7.2 | −14.8 | −12.9 | −11.6 | 256 | 3.5 | 0.6 | −1.3 |
| Li₄V₂FeSnO₈ | 7.2 | 9.1 | 8.5 | 11.7 | 224 | 2.8 | 1.8 | −3.2 |
| Li₄TiVFe₂O₈ | 7.6 | −3.9 | −4.1 | 3 | 195 | 3.2 | 1.4 | −7.1 |
| Li₄Cr₂CuNiO₈ | 7.7 | −5 | −6.9 | 26.3 | 313 | 3.4 | 1.2 | −33.2 |
| Li₄MnNbFe₂O₈ | 8.4 | 33.8 | 28.1 | 18.5 | 174 | 3.3 | 0.9 | 9.6 |
| Li₄NbFe₂NiO₈ | 8.5 | 22.7 | 28.8 | 16.8 | 173 | 3.4 | 0.4 | 12 |
| Li₄V₂GaFeO₈ | 8.6 | −0.7 | 1.7 | 16.1 | 187 | 3.1 | 1.7 | −14.4 |
| Li₄V₃FeO₈ | 8.8 | −2.5 | −1 | 10.9 | 327 | 3.1 | 1.8 | −11.8 |
| Li₄AlV₂FeO₈ | 9.1 | −8.2 | −5.3 | 14.9 | 208 | 3 | 1.7 | −20.2 |
| Li₄CrNi₂SnO₈ | 9.1 | 1.3 | 1.7 | 22.7 | 219 | 3.1 | 0.5 | −21 |
| Li₄TiCrNi₂O₈ | 9.4 | −5.6 | −1.8 | 18 | 256 | 3.2 | 0.8 | −19.7 |
| Li₂CrCuO₄ | 26.1 | 9.9 | 16.4 | 45.3 | 248 | 3.3 | 1.2 | −28.9 |

The second subset of cathode material compositions selected at 270 included Li_{4+δ}CrFeNi₂O₈, Li_{4+δ}CrFe₂NiO₈, Li_{4+δ}TiCrNi₂O₈, Li_{4+δ}Cr₂FeNiO₈, Li_{4+δ}Cr₂FeCuO₈, Li_{4+δ}Cr₂GaFeO₈, Li_{4+δ}TiCr₂CuO₈, and Li_{2+δ}CrCuO₄. Accordingly, from approximately six thousand possible cathode material compositions, the method 20 provided a list of nine new cathode materials that exhibit a tendency for being synthesized and stable with a DRX crystal structure phase, and have desirable calculated voltage discharge, discharge capacity, and/or oxygen stability.

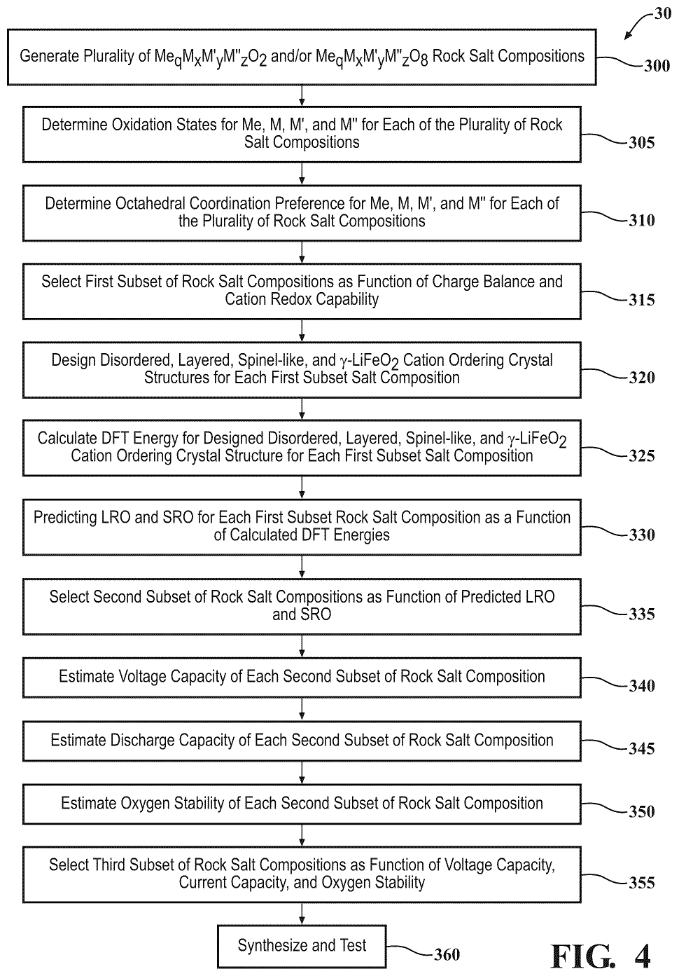

Referring to FIG. 4, another method 30 of discovering DRX and/or DRY/layered cathode materials includes generating a plurality of cathode material compositions having the Li_{4+δ}Mₓ₁M′_{y1}M″_{z1}O₈ or Li_{2+δ}Mₓ₂M′_{y2}M″_{z2}O₄ chemical formula noted above at 300. For example, in some variations, thousands of possible cathode material compositions are generated at 300. The method 30 includes determining oxidation states of M, M′, and M″ at 305 and determining octahedral coordination preference for M, M′, and M″ at 310. The oxidation state determination of M, M′, and M″ and the octahedral coordination preference for M, M′, and M″ allows for selection of a first subset of cathode material compositions as a function of charge balance and cation redox capability at 315. For example, in some variations each of the first subset of cathode material compositions are selected as being charge balanced and having a redox capability of extracting at least 0.5 Li per formula unit. And in at least one variation, the first subset of cathode material compositions is the forty-four (44) cathode material compositions shown in Table 1.

At 320, the method 30 includes designing cation ordering crystal structures (e.g., disordered, layered, spinel-like, and γ-LiFeO₂-like cation ordering crystal structures) for each of the first subset of cathode material compositions and a first principle energy calculation (e.g., DFT energy calculation) is performed on each cation ordering crystal structure for each of the first subset of cathode material compositions at 325. The method 30 proceeds to 330 where the calculated first principle energy calculations are used for predicting the long-range order (LRO) and the short-range order (SRO) for each cation ordering crystal structure of each of the first subset of cathode material compositions, and a second subset of cathode material compositions is selected from the first subset of cathode material compositions as a function of the predicted LRO and SRO for each cation ordering crystal structure of each of the first subset of cathode material compositions at 335.

The method 30 further includes estimating the charge capacity of each of the second subset of cathode material compositions at 340, estimating the discharge capacity of each of the second subset of cathode material compositions at 345, and estimating the oxygen stability of each of the second subset of cathode material compositions at 350. In some variations, at least one of the second subset of cathode of material compositions is synthesized and evaluated.

A third subset of cathode material compositions is selected from the second subset of cathode material compositions as a function of the estimated charge capacity, discharge capacity, and oxygen stability at 355. In some variations, the third subset of cathode material compositions includes Li_{4+δ}CrFeNi₂O₈, Li_{4+δ}CrFe₂NiO₈, Li_{4+δ}TiCrNi₂O₈, Li_{4+δ}Cr₂FeNiO₈, Li_{4+δ}Cr₂FeCuO₈, Li_{4+δ}Cr₂GaFeO₈, and Li_{4+δ}TiCr₂CuO₈. And in at least one variation, the third subset of cathode material compositions are synthesized and evaluated at 360.

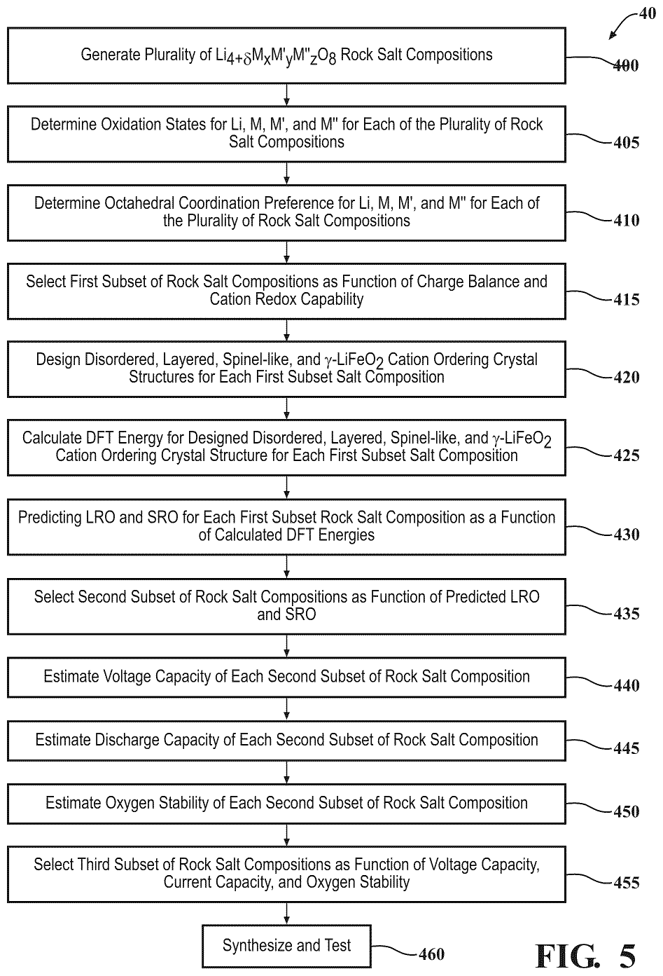

Referring to FIG. 5, still another method 40 of discovering lithium DRX cathode materials includes generating a plurality of cathode material compositions have the Li_{4+δ}Mₓ₁M′_{y1}M″_{z1}O₈ or Li_{2+δ}Mₓ₂M′_{y2}M″_{z2}O₄ chemical formula noted above at 400, determining oxidation states of Li, M, M′, and M″ in each of the cathode material compositions at 405, and determining octahedral coordination preference for Li, M, M′, and M″ in each of the cathode material compositions at 410. The oxidation state determination of Li, M, M′, and M″ and the octahedral coordination preference for Li, M, M′, and M″ allows for selection of a first subset of cathode material compositions as a function of charge balance and cation redox capability at 415. For example, in some variations each of the first subset of cathode material compositions are selected as being charge balanced and having a redox capability of extracting at least 0.5 Li per formula unit. And in at least one variation, the first subset of cathode material compositions is the forty-four (44) cathode material compositions shown in Table 1.

The method 40 further includes designing the four disordered, layered, spinel-like, and γ-LiFeO₂-like cation ordering crystal structures for each of the first subset of cathode material compositions at 420 and calculating DFT energy for each cation ordering crystal structure of each of the first subset of cathode material compositions at 425. The method 40 proceeds to 430 where the calculated DFT energies are used for predicting the long-range order (LRO) and the short-range order (SRO) for each cation ordering crystal structure of each of the first subset of cathode material compositions, and a second subset of cathode material compositions is selected from the first subset of cathode material compositions as a function of the predicted LRO and SRO for each cation ordering crystal structure of each of the first subset of cathode material compositions at 435.

The method 40 further includes estimating the charge capacity of each of the second subset or cathode material compositions at 440, estimating the discharge capacity of each of the second subset or cathode material compositions at 445, and estimating the oxygen stability of each of the second subset or cathode material compositions at 450. A third subset of cathode material compositions is selected from the second subset of cathode material compositions as a function of the estimated charge capacity, discharge capacity, and oxygen stability at 455. In some variations, the third subset of cathode material compositions includes Li_{4+δ}CrFeNi₂O₈, Li_{4+δ}CrFe₂NiO₈, Li_{4+δ}TiCrNi₂O₈, Li_{4+δ}Cr₂FeNiO₈, Li_{4+δ}Cr₂FeCuO₈, Li_{4+δ}Cr₂GaFeO₈, Li_{4+δ}TiCr₂CuO₈, and Li_{2+δ}CrCuO₄. And in at least one variation, the third subset of cathode material compositions are synthesized and evaluated at 460.

In order to better illustrate the teachings of the present disclosure and yet not limit the scope thereof in any way, prediction of DRX compounds versus successfully synthesized DRX compounds are discussed below. Particularly, and with reference to Table 2 below, LRO predictions based on approximate free energyF(meV/atom)=Eₕᵤₗₗ−TS_{config}, and x-ray diffraction (XRD) results for the second subset of cathode material compositions selected at step 270 of the method 20 or the third subset of cathode material compositions selected at step 355 of method 30 or step 455 of method 40 are shown.

TABLE 2

| | | | | | Stoichiometric | 20% Li-excess |
|---|---|---|---|---|---|---|
| Composition | F_{DRX} | F_{layered} | Fₛₚᵢₙₑₗ₋ₗᵢₖₑ | Fγ_{-LiFeO2} | phase | phase |
| Li₄CrFeNi₂O₈ | −13 | −9 | −16 | 4 | DRX | DRX |
| Li₄CrFe₂NiO₈ | −9 | −28 | −24 | −5 | DRX | DRX |
| Li₄Cr₂FeNiO₈ | 4 | −28 | −28 | 0 | DRX + | DRX + |
| | | | | | Layered | Layered |
| Li₄TiCrNi₂O₈ | 5 | −9 | −8 | 11 | DRX | DRX |
| Li₄Cr₂FeCuO₈ | 8 | 2 | 0 | 11 | Layered + | Layered + |
| | | | | | little | impurities |
| | | | | | impurities | LiCuO |
| Li₂CrCuO₄ | 19 | 6 | 2 | 37 | Layered + | Layered + |
| | | | | | impurities | impurities |
| Li₄Cr₂GaFeO₈ | 35 | −16 | −15 | 13 | Layered | Layered |
| Li₄TiCr₂CuO₈ | 45 | 2 | 9 | 21 | Layered + | Layered + |
| | | | | | little | little |
| | | | | | impurities | impurities |
| | | | | | CuO and | CuO and |
| | | | | | Li₂CrO₄ | Li₂CrO₄ |

The compositions shown in Table 2 were synthesized stoichiometrically (labeled “Stoichiometric phase”) and with 2000 Li-excess (labeled “20% Li-excess phase”) with the number of cations adjusted accordingly. The compositions were prepared using solid-state synthesis, which entails combining/mixing precursors together before treatment at high temperature in a furnace. Also, the precursors were: Li2CO3 (Wako, 99.0%), Cr2O3 (Nacalai Tesque, 98.5%), Fe2O3 (Kojundo chemical laboratory, 99.9%), Ga2O3 (Wako, 99.99%), NiO(Wako, 99.9%), CuO(Wako, 95.0%), TiO2 (Wako, 99.0%), and ZrO2 (Wako, 98.0%). The appropriate precursors (raw materials) were mixed in stoichiometric composition quantities, except for Li₂CO₃, which was included with 3% excess. A mixture of 3 grams of raw materials and 6 milliliters of ethanol was placed in a 45 mL ball milling pot and wet ball milled at 300 rpm for 255 minutes to form a slurry using a Pulversettle 7 (FRITSCH) ball mill. The slurry was dried at 120° C. under vacuum to form a dry powder and the dry powder was placed in a boat-shaped crucible with copper foil wrapped around it and sintered at 1000° C. in a furnace for 12h in an argon (Ar) or air atmosphere to form a sintered sample. The sintered sample was then taken out of the furnace at 120° C. and quickly transferred to an Ar atmosphere glove box to minimize air exposure. Inside the glove box, the sintered sample was ground with an agate mortar to form a sintered powder and fine DRX particles were formed (when present) by placing 1 gram of the sintered powder into a ball milling pot in an Ar-glove box and balled milling at 600 rpm for 30 hours using the Pulversettle 7 ball mill. In addition, crystal structures of the powders were measured using an X-ray diffractometer with Cu-Kα radiation in the range of 5-120° with a 0.005° step and a 2° min⁻¹ scan speed.

As observed from Table 2, three (3) of the eight synthesized cathode material compositions had the DRX crystal structure and one of the synthesized cathode material compositions had a DRX+layered crystal structure. Accordingly, the methods disclose herein took an initial set of 6,000 possible cathode material compositions and provided a set of eight cathode material compositions for synthesis, and 50% of the synthesized cathode material compositions exhibited at least some DRX crystal structure and 37.5% of the synthesized cathode material compositions exhibited a complete DRX crystal structure (i.e., the DRX crystal structure was the only phase present).

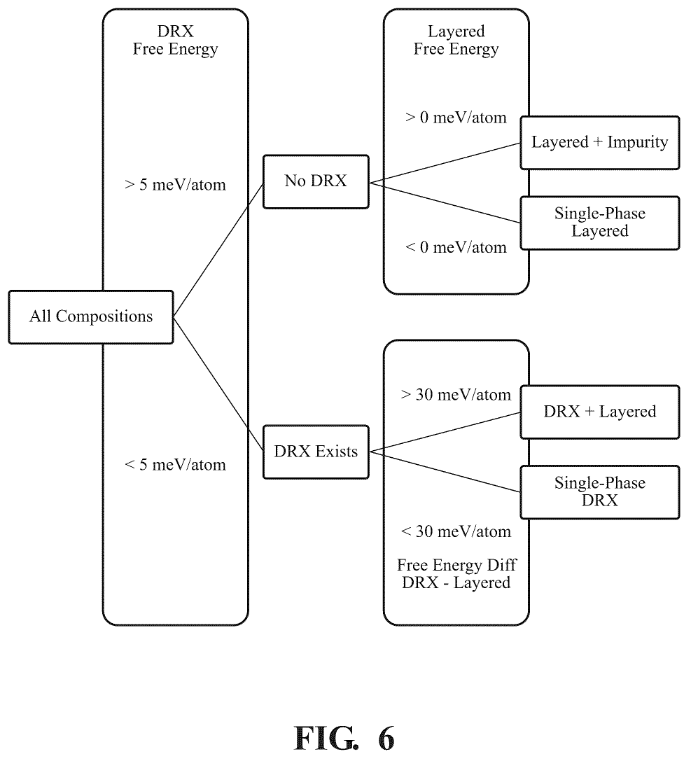

Referring now to FIG. 6, an empirical decision tree derived from the data in Table 2 is shown to clarify correlations between the formation energy estimations and observed phases. Particularly, the presence or existence of the DRX phase is favored for lower estimated values of F_{DRX}, i.e., compositions containing the DRX phase in the synthesized compounds all have lower F_{DRX} values. In addition, the four synthesized compounds that exhibited the DRX phase (Li₄CrFeNi₂O₈, Li₄CrFe₂NiO₈, Li₄Cr₂FeNiO₈, Li₄TiCrNi₂O₈) also had a negative F_{layered}, and three of the compounds had F_{layered}<F_{DRX}. However, it was observed that the composition with the largest difference between F_{DRX} and F_{layered} (Li₄Cr₂FeNiO₈) exhibited the coexistence of the DRX and layered phases. Not being bound by theory, such an observation suggests overestimations of the metal-ion layer mixing entropy, since only S_{config} was included in the estimations, and the enthalpy portion for the DRX estimations may be overestimated due to the absence of the SRO contribution. Accordingly, the F_{layered} estimation may have been over stabilized compared to the F_{DRX} estimation.

Based on the teachings of the present disclosure it should be understood that cathodes formed from new cathode material compositions and methods for discovering new cathode materials for cathodes are provided. In some variations, the cathodes are formed from only one of the new cathode material compositions, while in other variations, a cathode is formed two or more new cathode material compositions. For example, in at least one variation a cathode is formed from a plurality of new cathode material compositions such as Li_{4+δ}CrFeNi₂O₈, Li_{4+δ}CrFe₂NiO₈, Li_{4+δ}TiCrNi₂O₈, Li_{4+δ}Cr₂FeNiO₈, Li_{4+δ}Cr₂FeCuO₈, Li_{4+δ}Cr₂GaFeO₈, Li_{4+δ}TiCr₂CuO₈, and/or Li_{2+δ}CrCuO₄.

While described as methods and illustrated with flowcharts, it should be understood that the present disclosure provides for systems that execute the methods described herein. For example, a system disclosed herein can include a processor, a memory communicably coupled to the processor and storing machine-readable instructions that, when executed by the processor, cause the processor to perform the methods and/or method steps disclosed herein, among others.

The preceding description is merely illustrative in nature and is in no way intended to limit the disclosure, its application, or uses. Work of the presently named inventors, to the extent it may be described in the background section, as well as aspects of the description that may not otherwise qualify as prior art at the time of filing, are neither expressly nor impliedly admitted as prior art against the present technology.

As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple variations or forms having stated features is not intended to exclude other variations or forms having additional features, or other variations or forms incorporating different combinations of the stated features.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. Atypical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk, C++, Python, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one variation, or various variations means that a particular feature, structure, or characteristic described in connection with a form or variation, or particular system is included in at least one variation or form. The appearances of the phrase “in one variation” (or variations thereof) are not necessarily referring to the same variation or form. It should also be understood that the various method steps discussed herein do not have to be carried out in the same order as depicted, and not each method step is required in each variation or form.

The foregoing description of the forms and variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

What is claimed is:

1. A cathode for a Li ion battery, the cathode comprising:
a cathode material with the chemical formula Li_{4+δ}Mₓ₁M′_{y1}M″_{z1}O₈ or Li_{2+δ}Mₓ₂M′_{y2}M″_{z2}O₄ where 0≤δ≤1, x1, y1, z1 are integers (+/−0.05) and x1+y1+z1=4, x2, y2, z2 are integers (+/−0.05) and x2+y2+z2=2, and M, M′, and M″ are elements selected independently from hafnium (Hf), magnesium (Mg), aluminum (Al), scandium (Sc), titanium (Ti), vanadium (V), chromium (Cr), manganese (Mn), iron (Fe), cobalt (Co), nickel (Ni), copper (Cu), gallium (Ga), zirconium (Zr), niobium (Nb), ruthenium (Ru), tin (Sn), and antimony (Sb).

2. The cathode according to claim 1, wherein the cathode material is selected from the group consisting of Li_{2+δ}TiVO₄, Li_{2+δ}VFeO₄, Li_{4+δ}HfTiV₂O₈, Li_{4+δ}VFe₂SnO₈, Li_{4+δ}ScV₂FeO₈, Li_{4+δ}CrFeNi₂O₈, Li_{4+δ}Mn₂CoRuO₈, Li_{4+δ}Mn₂NiRuO₈, Li_{4+δ}CrFe₂NiO₈, Li_{4+δ}HfCrFe₂O₈, Li_{4+δ}ZrV₃O₈, Li_{4+δ}Mn₂NiSbO₈, Li_{4+δ}Mn₂CoSbO₈, Li_{4+δ}Cr₂FeCuO₈, Li_{4+δ}Cr₂FeNiO₈, Li_{4+δ}TiCrFe₂O₈, Li_{4+δ}HfV₃O₈, Li_{4+δ}Mn₂FeRuO₈, Li_{4+δ}MnCrNi₂O₈, Li_{4+δ}Cr₂GaFeO₈, Li_{4+δ}ZrCrFe₂O₈, Li_{4+δ}Ti₂VCrO₈, Li_{4+δ}ZrV₂FeO₈, Li_{4+δ}FeCo₂RuO₈, Li_{4+δ}Fe₂CoRuO₈, Li_{4+δ}CrFe₂SnO₈, Li_{4+δ}CrFe₂CuO₈, Li_{4+δ}Fe₂NiSbO₈, Li_{4+δ}ScMnV₂O₈, Li_{4+δ}ScTiV₂O₈, Li_{4+δ}MnV₂FeO₈, Li_{4+δ}MnCo₂RuO₈, Li_{4+δ}HfV₂FeO₈, Li_{4+δ}TiCr₂CuO₈, Li_{4+δ}TiV₃O₈, Li_{4+δ}ScCr₂NiO₈, Li_{4+δ}Mn₂CrFeO₈, Li_{4+δ}V₂FeSnO₈, Li_{4+δ}TiVFe₂O₈, Li_{4+δ}Cr₂CuNiO₈, Li_{4+δ}MnNbFe₂O₈, Li_{4+δ}NbFe₂NiO₈, Li_{4+δ}V₂GaFeO₈, Li_{4+δ}V₃FeO₈, Li_{4+δ}AlV₂FeO₈, Li_{4+δ}CrNi₂SnO₈, and Li_{4+δ}TiCrNi₂O₈.

3. The cathode according to claim 1, wherein the cathode material comprises Li_{4+δ}CrFeNi₂O₈, Li_{4+δ}CrFe₂NiO₈, Li_{4+δ}TiCrNi₂O₈, Li_{4+δ}Cr₂FeNiO₈, Li_{4+δ}Cr₂FeCuO₈, Li_{4+δ}Cr₂GaFeO₈, Li_{4+δ}TiCr₂CuO₈, and Li_{2+δ}CrCuO₄.

4. The cathode according to claim 1, wherein the cathode material is selected from the group consisting of Li_{4+δ}CrFeNi₂O₈, Li_{4+δ}CrFe₂NiO₈, Li_{4+δ}TiCrNi₂O₈, Li_{4+δ}Cr₂FeNiO₈, Li_{4+δ}Cr₂FeCuO₈, Li_{4+δ}Cr₂GaFeO₈, Li_{4+δ}TiCr₂CuO₈, and Li_{2+δ}CrCuO₄.

5. The cathode according to claim 4, wherein the cathode material comprises a crystal structure selected from the group consisting of a disordered-rock-salt crystal structure, a layered crystal structure, and combinations thereof.

6. The cathode according to claim 5, wherein the cathode material is Li_{4+δ}CrFeNi₂O₈.

7. The cathode according to claim 5, wherein the cathode material is Li_{4+δ}CrFe₂NiO₈.

8. The cathode according to claim 5, wherein the cathode material is Li_{4+δ}TiCrNi₂O₈.

9. The cathode according to claim 5, wherein the cathode material is Li_{4+δ}Cr₂FeCuO₈.

10. The cathode according to claim 5, wherein the cathode material is Li_{4+δ}Cr₂GaFeO₈.

11. The cathode according to claim 5, wherein the cathode material is Li_{4+δ}TiCr₂CuO₈.

12. The cathode according to claim 5, wherein the cathode material is Li_{2+δ}CrCuO₄.

13. A method comprising:
estimating synthesizability and metal-ion diffusion availability for a plurality of cathode material compositions with the chemical formula Li_{4+δ}Mₓ₁M′_{y1}M″_{z1}O₈ or Li_{2+δ}Mₓ₂M′_{y2}M″_{z2}O₄ where 0≤δ<1, x1+y1+z1=4, x2+y2+z2=2, and M, M′, and M″ are at least two different cation elements;
selecting a first subset of cathode material compositions from the plurality of cathode material compositions as a function of the estimated synthesizability and metal-ion diffusion availability;
estimating voltage discharge, charge capacity, and oxygen stability for the first subset of cathode material compositions;
selecting a second subset of cathode material compositions from the first subset of cathode material compositions as a function of the estimated voltage discharge, charge capacity, and oxygen stability; and
synthesizing and evaluating at least one of the second subset of cathode material compositions.

14. The method according to claim 13, wherein M, M′, and M″ are selected independently from hafnium (Hf), magnesium (Mg), aluminum (Al), scandium (Sc), titanium (Ti), vanadium (V), chromium (Cr), manganese (Mn), iron (Fe), cobalt (Co), nickel (Ni), copper (Cu), gallium (Ga), zirconium (Zr), niobium (Nb), ruthenium (Ru), tin (Sn), and antimony (Sb).

15. The method according to claim 14 further comprising:
determining available oxidation states of the at least two different cation elements for the plurality of cathode material compositions;
determining octahedral coordination preference of the at least two cation elements for the plurality of cathode material compositions;
selecting a first subset of cathode material compositions from the plurality of cathode material compositions as a function of charge balance and cation redox capability;
designing disordered, layered, spinel-like, and γ-LiFeO₂-like cation ordering crystal structures for the first subset of cathode material compositions;
performing first principle energy calculations for each of the disordered, layered, spinel-like, and γ-LiFeO₂-like cation ordering crystal structures for each of the subset cathode material compositions;
predicting long-range order and/or short-range order for as a function of the first principle energy calculations for each of the disordered, layered, spinel-like, and γ-LiFeO₂-like cation ordering crystal structures for each of the subset cathode material compositions; and
selecting the second subset of cathode material compositions from the first subset of cathode material compositions as a function of the predicted long rang order and/or short-ranger order.

16. The method according to claim 15 further comprising:
estimating a charge capacity of each of the second subset of cathode material compositions as a function of oxidation state values for each element of each of the second subset of cathode material compositions; and
estimating an oxygen stability of each of the second subset of cathode material compositions as a function of oxygen vacancy formation energy calculations for each of the second subset of cathode material compositions.

17. The method according to claim 16 further comprising:
selecting a third subset of cathode material compositions from the second subset of cathode material compositions as a function of the estimated charge capacity and the estimated oxygen stability of each of the second subset of cathode material compositions; and
synthesizing the third subset of cathode material compositions.

18. The method according to claim 17, wherein the second subset of cathode material compositions comprises Li_{2+δ}TiVO₄, Li_{2+δ}VFeO₄, Li_{4+δ}HfTiV₂O₈, Li_{4+δ}VFe₂SnO₈, Li_{4+δ}ScV₂FeO₈, Li_{4+δ}CrFeNi₂O₈, Li_{4+δ}Mn₂CoRuO₈, Li_{4+δ}Mn₂NiRuO₈, Li_{4+δ}CrFe₂NiO₈, Li_{4+δ}HfCrFe₂O₈, Li_{4+δ}ZrV₃O₈, Li_{4+δ}Mn₂NiSbO₈, Li_{4+δ}Mn₂CoSbO₈, Li_{4+δ}Cr₂FeCuO₈, Li_{4+δ}Cr₂FeNiO₈, Li_{4+δ}TiCrFe₂O₈, Li_{4+δ}HfV₃O₈, Li_{4+δ}Mn₂FeRuO₈, Li_{4+δ}MnCrNi₂O₈, Li_{4+δ}Cr₂GaFeO₈, Li_{4+δ}ZrCrFe₂O₈, Li_{4+δ}Ti₂VCrO₈, Li_{4+δ}ZrV₂FeO₈, Li_{4+δ}FeCo₂RuO₈, Li_{4+δ}Fe₂CoRuO₈, Li_{4+δ}CrFe₂SnO₈, Li_{4+δ}CrFe₂CuO₈, Li_{4+δ}Fe₂NiSbO₈, Li_{4+δ}ScMnV₂O₈, Li_{4+δ}ScTiV₂O₈, Li_{4+δ}MnV₂FeO₈, Li_{4+δ}MnCo₂RuO₈, Li_{4+δ}HfV₂FeO₈, Li_{4+δ}TiCr₂CuO₈, Li₄,TiV₃O₈, Li_{4+δ}ScCr₂NiO₈, Li_{4+δ}Mn₂CrFeO₈, Li_{4+δ}V₂FeSnO₈, Li_{4+δ}TiVFe₂O₈, Li_{4+δ}Cr₂CuNiO₈, Li_{4+δ}MnNbFe₂O₈, Li_{4+δ}NbFe₂NiO₈, Li_{4+δ}V₂GaFeO₈, Li_{4+δ}V₃FeO₈, Li_{4+δ}AlV₂FeO₈, Li_{4+δ}CrNi₂SnO₈, and Li_{4+δ}TiCrNi₂O₈.

19. The method according to claim 18, wherein the third subset of cathode material compositions comprises Li_{4+δ}CrFeNi₂O₈, Li_{4+δ}CrFe₂NiO₈, Li_{4+δ}TiCrNi₂O₈, Li_{4+δ}Cr₂FeNiO₈, Li_{4+δ}Cr₂FeCuO₈, Li_{4+δ}Cr₂GaFeO₈, Li_{4+δ}TiCr₂CuO₈, and Li_{2+δ}CrCuO₄.

20. The method according to claim 19 further comprising forming a cathode from one of the third subset of cathode material compositions.
